(19) United States
(12) Patent Application Publication
(10) Pub. No.: US 2015/0262287 A1
(43) Pub. Date: Sep. 17, 2015

(54) Method and System for Conducting Electronic Commerce, Gifting, and Invitation Through Electronic Greeting Card and Greeting Video

(71) Applicant: Catherine G. Lin-Hendel, Summit, NJ (US)

(72) Inventor: Catherine G. Lin-Hendel, Summit, NJ (US)

(21) Appl. No.: 14/216,837

(22) Filed: Mar. 17, 2014

(51) Int. Cl. G06Q 30/06; G06Q 20/28

(52) U.S. Cl. CPC G06Q 30/0643; G06Q 20/28

(57) ABSTRACT

Systems and method for conducting on-line commerce are disclosed. The method includes creating an electronic card that contains a pictorial representation of at least one object available for a commercial transaction; associating the pictorial representation of the at least one object with a URL link to a webpage containing information about the least one object; providing on the electronic card a pathway for conducting a commercial transaction related to the at least one object; and sending the electronic card in association with an electronic message to a recipient.

### CROSS REFERENCE TO RELATED APPLICATIONS

This application claims the benefit of U.S. Provisional Application Ser. No. 61/800,984, filed Mar. 15, 2013, entitled “Method and System for Conducting Electronic Commerce, Gifting, and Invitation through Electronic Greeting Card and Greeting Video” which is hereby incorporated by reference in its entirety.’

### BACKGROUND OF THE INVENTION

1 Field of Invention The present invention is in the field of Personalized Electronic Commerce

2. Description of the Background

Conventional Electronic Commerce is conducted through merchant websites or shopping portals, where catalog of products is organized by categories for shoppers to search, browse, and shop. A search function is also available on these sites for shoppers to search for products with key words. Merchant site can also send news-mails on discounts or special sales to shoppers who have signed up on the merchant site agreeing to receive email notifications from the merchant site. Discount sites such as Groupon send emails to members teasing discount deals.

In the age of too many things for sale, and too little time, the above mentioned e-commerce method are laborious and no longer adequate, especially when a purchase is for a gift or an invitation. For example, one can purchase a product and simply bring it or sent it to the receiver of the intended gift, and risk it not liked or being duplicative of what the receiver already has. You can copy and paste a picture of a product from a merchant site that you think may be the gift receiver will like, log the merchant name, link, and the price of the product separately, and sent the picture in an email to the receiver to ask whether she would like to have it as a gift. You can go back and forth a few times, one product at a time, a laborious and time consuming task. You can also “share” the link. In this case, an URL link will be emailed to the intended receiver. This is also one link at a time. Such inefficient gift purchasing negatively impacts the revenue and profit potentials of merchants.

Electronic Greeting Cards (including videos and audios) has become very popular that they have replaced the paper greeting cards for many people. Sites that are dedicated to facilitate electronic group planning and invitations are also widely used. However, any transactional or commerce activity that are connected to greetings, special occasions, invitations, gifting, gift registry, group activity announcement, activity planning and invitations are conducted in entirely separate venues from sending, receiving, and responding to the electronic greeting, invitation, or group activity planning and announcement. This is inconvenient, laborious, and time consuming for the parties involved.

### BRIEF DESCRIPTION OF THE FIGURES

FIG. 1: Example features and functionality of E-Commerce E-Card of the present invention.

FIG. 2: Example procedure for composing and sending an E-Commerce E-Card (ECEC) on a Merchant website.

FIG. 3: Example procedure for composing and sending an E-Commerce E-Card on an E-Card E-Composition Hosting site.

FIG. 4: An example of an E-Commerce E-Card composed from a gift Portal Website

FIG. 5: An example of an E-Commerce E-Card creation process on an Art Photography Site.

FIG. 6: An example of an E-Commerce E-Card.

FIG. 7: An example of an E-Commerce E-Card on a social media site.

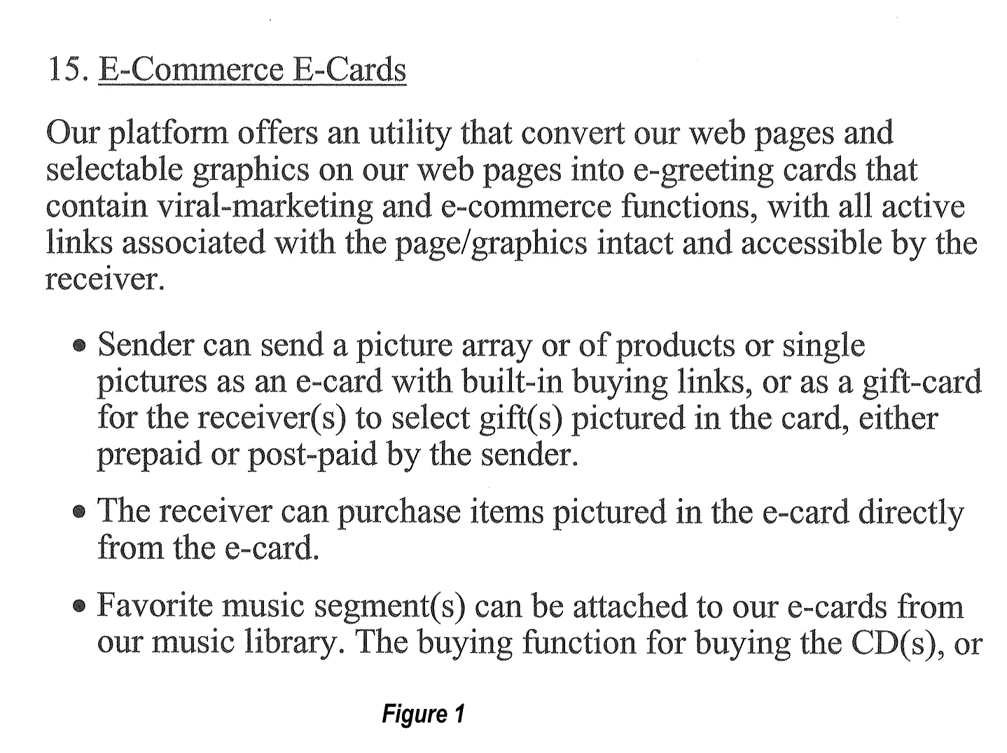

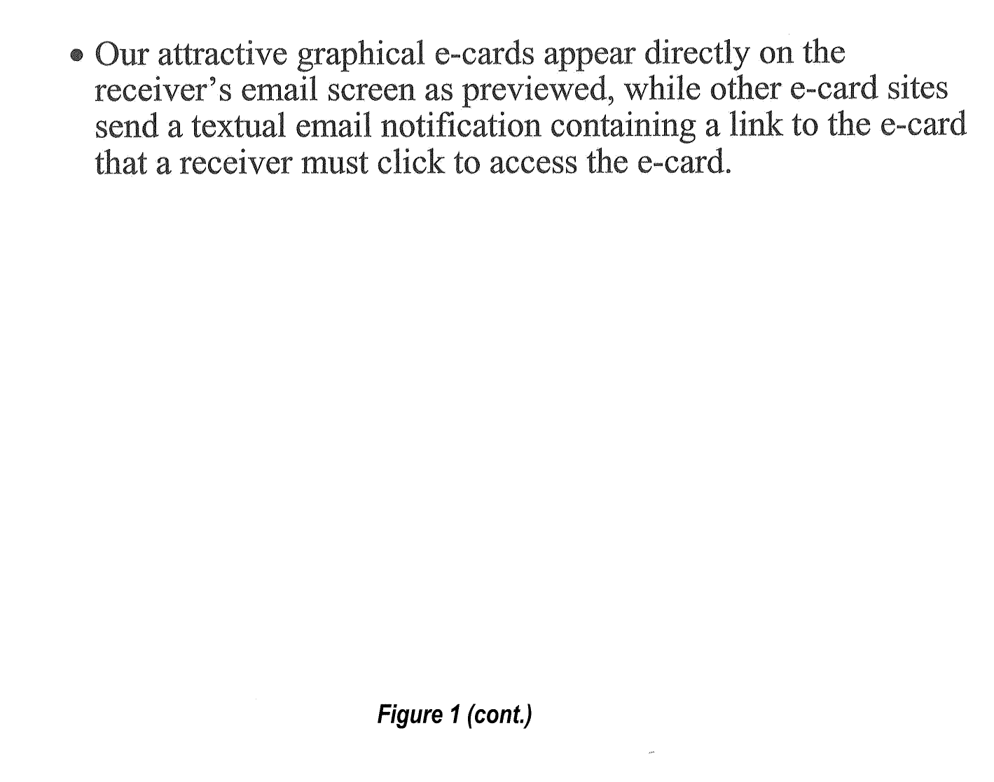

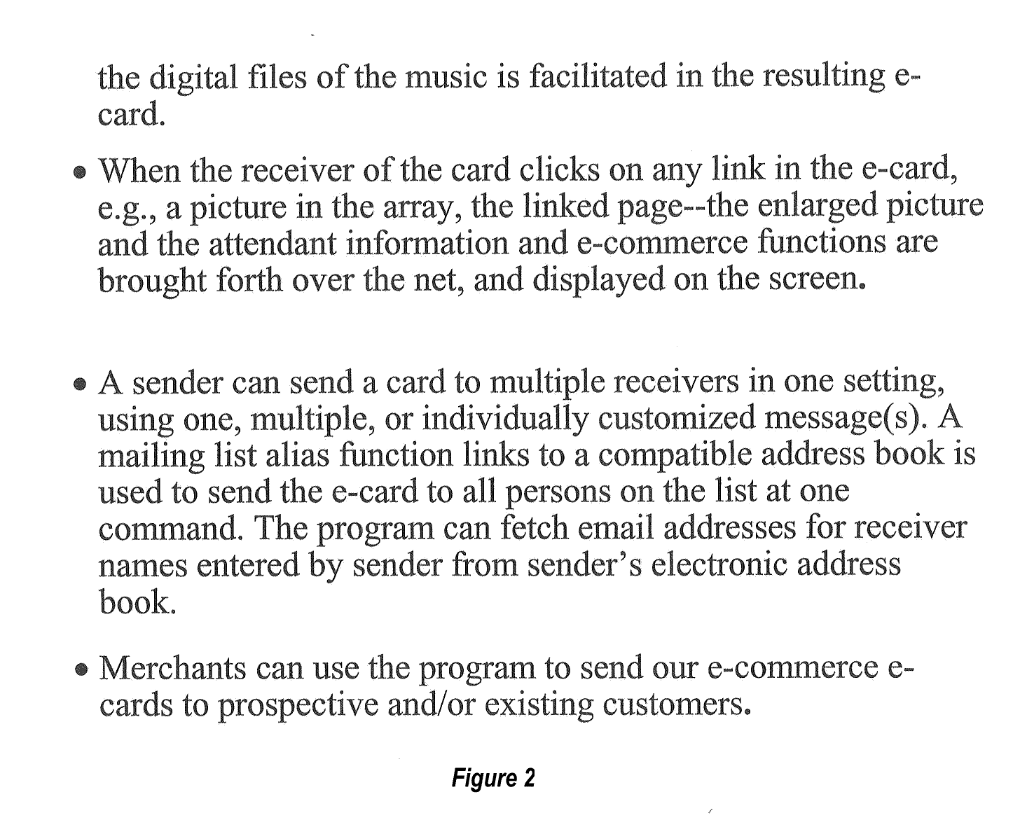

### DETAILED DESCRIPTION OF THE INVENTION

The present invention enables electronic commerce functions and advertising and promotion functions through attractive and entertaining electronic greeting cards and videos, electronic invitations, personalized “sharing,” and group activity announcements by enabling these functions in combination with one or more pathways for conducting commercial transactions on a merchant site, a gift registry site, a social media site, a group activity planning and invitation site, a gift portal site, a greeting card site, etc. Alternatively, these functions can be a portal service provided to both merchant sites and shoppers.

Attractive graphics, descriptions, audio, and/or video representations of an object, such as merchandise, gifts, art, a restaurant, an event, a movie trailer, a park, etc., appearing on the internet, as well as their buying channels or pathways, and/or gifting mechanism can be selected by a sender to compose an electronic greeting, notification, announcement, or “sharing” card, and send to an intended receiver. A merchant can also pre-compose such e-commerce enabled e-cards to deposit in a repository, accessible and viewable by a sender to select and customize before sending. On the composition screen, Entry boxes to enter a receiver name and email address or a list of receivers, a message, a facility to create check-box selection option, event time, response box and response by certain time frame, can be facilitated on the E-Card composition screen. An adequate editing function is provided in the E-Commerce E-Card Composition function in both the initial composition end, and in the receiving end. The sender-composer can determine the degree of information detail of the objects to be attainable through the sent E-Card, and whether to put the commercial transaction link into the e-card, or only a pathway to commercial transaction. A version of the composed e-card with links to more detailed information and commercial transaction venue for each object in the E-Commerce E-Card is embedded and attached to the object's representation/presentation graphics, picture, or video in the E-Commerce E-Card.

Alternately the greeting, invitation, announcement, or gift card composition options can be added to an electronic display of a merchandize or service, or even a home page display of a commerce site. The electronic greeting/invitation/announcement/gift card here denotes a broader meaning of a “card,” to be an electronically presented, transmitted, and received greetings, invitations, announcements, or gifting, including static text, graphics, photography, with embedded voice and/or music, dynamic animation, video or a combination of some of the above formats.

In another embodiment, a website host the method and system described in the present invention, where a site visitor can pick and choose graphics, pictures, and videos to compose and customize an electronic greeting, invitation, announcement, or sharing card, where solicitation for response and comments are furnished on the card, and responses automatically collected and tallied in the sender account with the composed card, as well as list of receivers sent the card, time sent, and the time each response is received. A repository of partially pre-composed E-Commerce E-Cards can also be hosted on the website for a site promoter or site visitor to select, customize, and send.

The present invention combines electronic commerce, gifting, and content customization functions with the conventional electronic greeting card functions. It enables showcasing, sharing, and purchasing of diverse gift items, such as art, furnishing, trips, spas, clothes, accessories, jewelries, inviting a friend or a loved one to go to a theater for a show, a movie, a concert, a ballet performance, to visit a park, a museum, or inviting a friend or a family member to a meal with companion wine and music in a restaurant or at home. The picture, the sound, a short video of the merchandise or event, and in the case of a meal, its recipe, description, the name and description of the wine, the picture of the restaurant, the table setting . . . etc., with sender selected music and customized words of greeting, comments, or invitation, composed and sent as an attractive greeting card, invitation, or an announcement of an event. A user can also simply compose an attractive information sharing card with purchase mechanism to a friend, who maybe having headache over what to give to his wife, redecorating a home, planning a dinner party, or planning a wedding. Or a marketer can compose an E-Commerce enabled E-Card to broadcast, or narrow-cast to potential customers. As an example, in the case of a dinner party, a picture of a table set with lovely dishes: appetizers, salads, entrees, deserts, wines, etc., with recipes and ingredients needed, an order mechanism for ingredients, or an order mechanism for a caterer to prepare and serve the dinner. Or, a lovely print of the Pyramids can be sent to friends when the sender or a friend either is planning a trip to, or returning from the Pyramids, with links in the card to worthy information or trip photos embedded with a pathway to browsing or booking the trip.

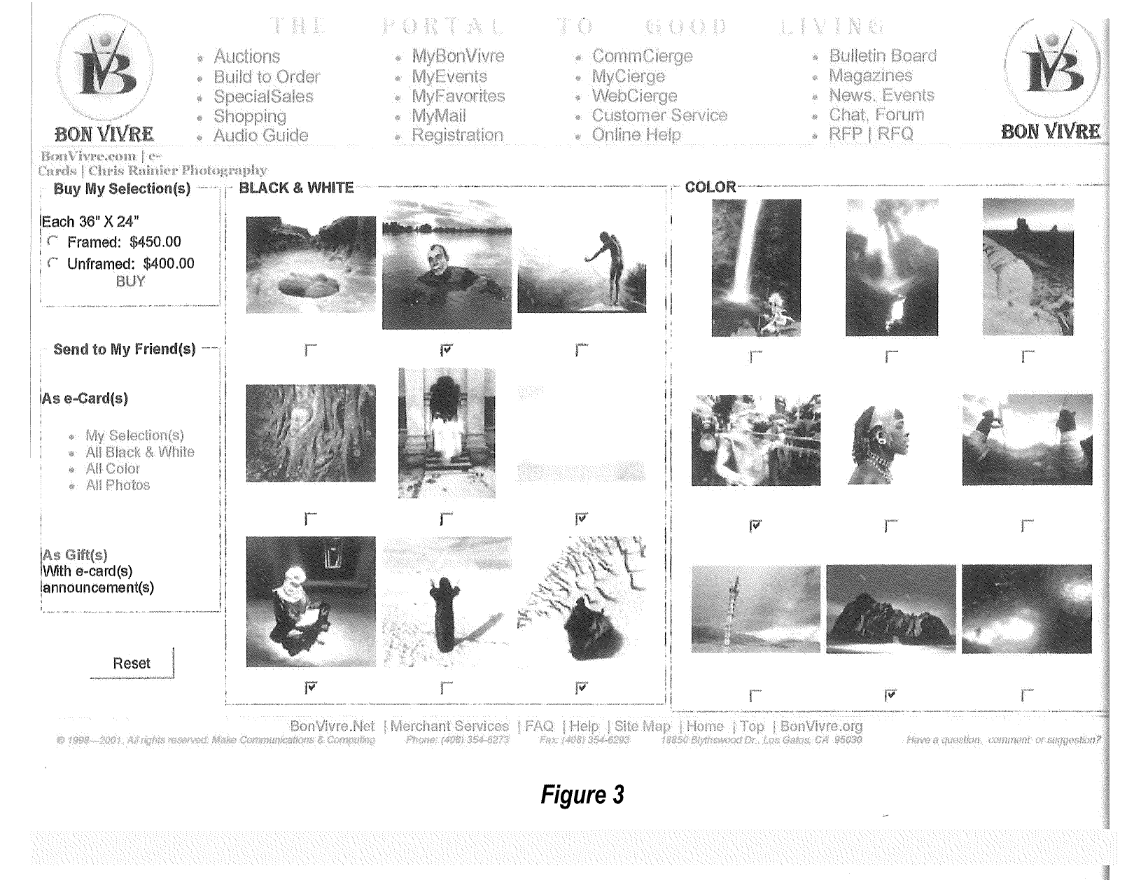

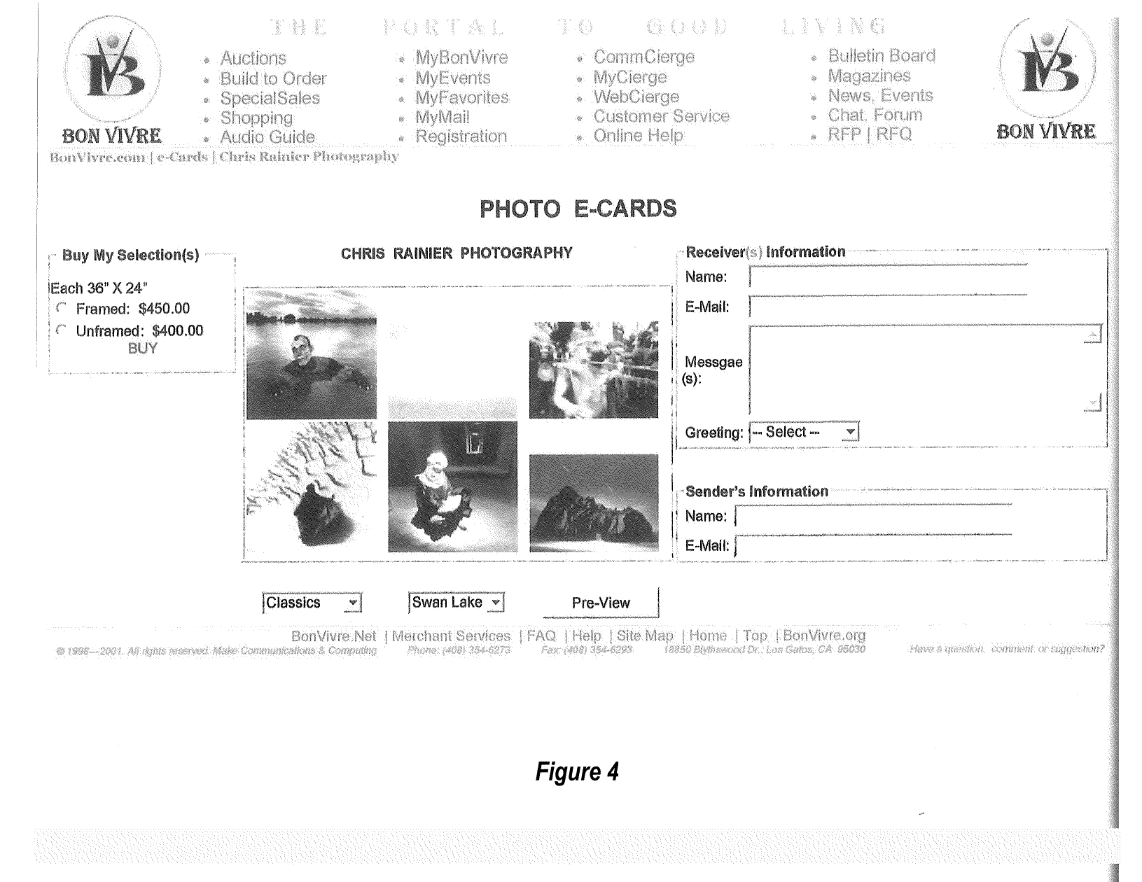

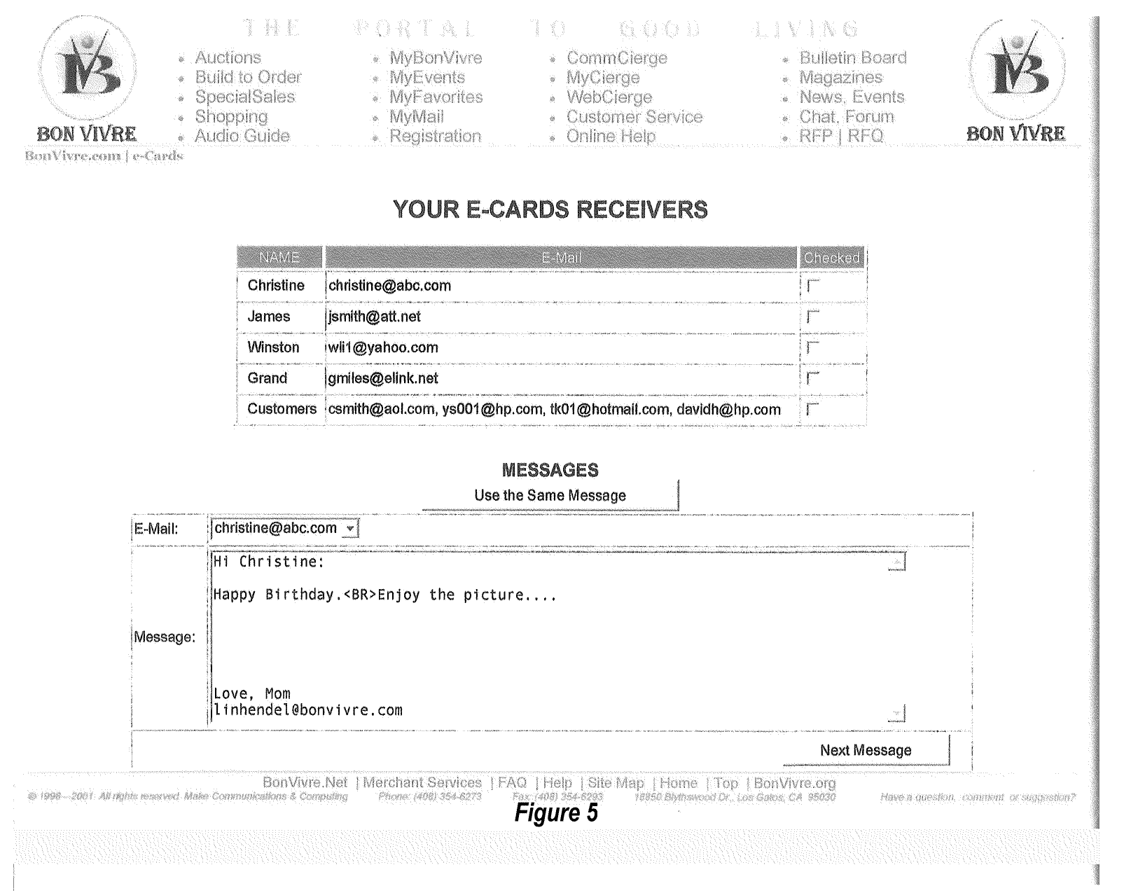

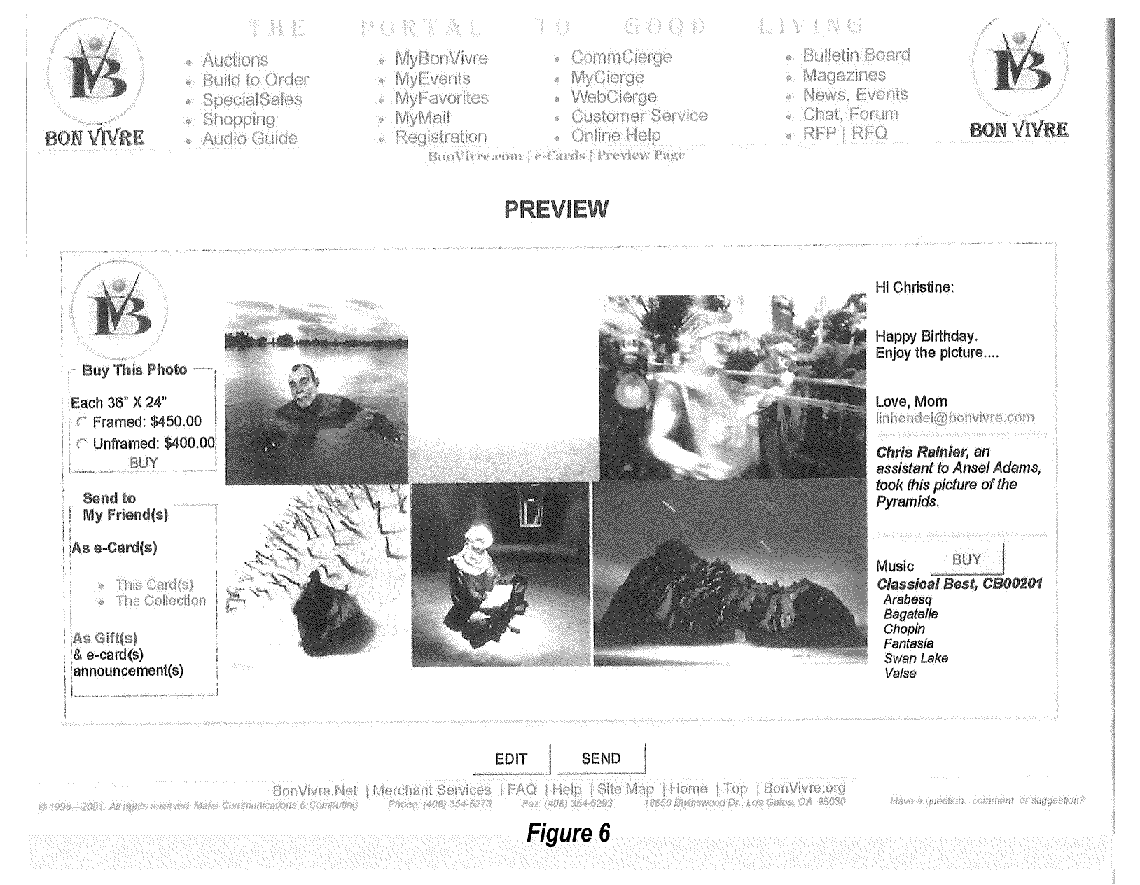

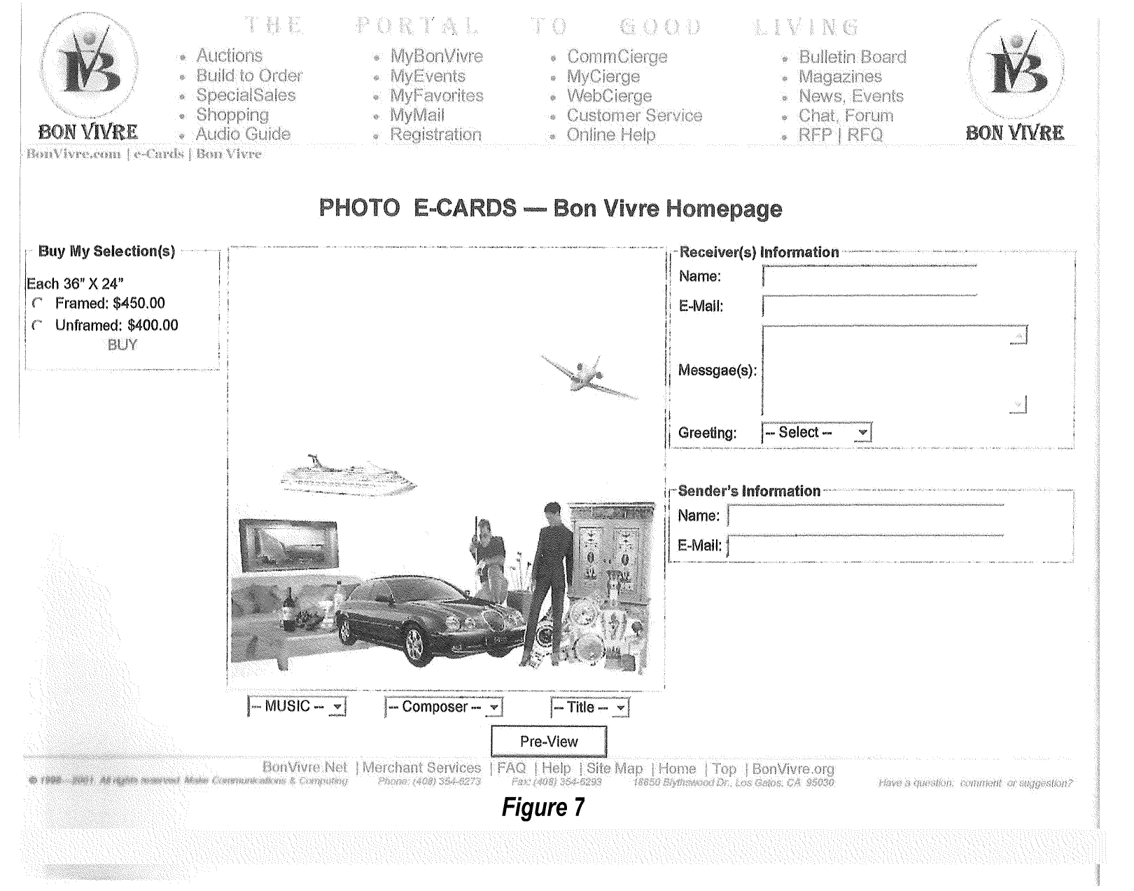

The multiple selection from multiple-item e-commerce greeting cards of this invention provides facility to package a selection of merchandize, gifts, or services in an array of thumbnails that can be send as an—commerce enabled electronic greeting card (s) for: (1) receiver(s) to choose one or multiple items from the array of items (FIG. 3); (2) for a pre-paid gift to a receiver to choose from the array of options, or (3) as a promotion/infomercial for a merchant or service provider of the merchandise and the services depicted. The same e-commerce e-card functions can also be embedded to any graphics and descriptions of a single item of merchandise, gifts, or service.

Using this invention, a second level (or third level, . . . etc.) e-commerce greeting card can be generated by the receiver of the card based on the E-commerce-E-Card received, which the receiver finds attractive and useful. The receiver can edit and send the E-Commerce E-Card generated to the receiver's friends, relatives, associates, or loved ones.

The invention also facilitates a merchant site, such that an entire web page can be sent as an e-commerce e-Card embedded with electronic commerce functions, by a site visitor to his connections, or by a site administrator to the site's members, or by a site promoter to past and present customers.

This invention also facilitates users to import their own graphics, media, and/or text either from their own sources or from libraries and catalogs available to them either online or offline beyond the service provider libraries.

The invention enables customization of a message sent to a receiver, or composing an universal message automatically fills in each receiver's name to the message from a mailing list and sending to the receivers on the mailing list. One single composed E-commerce-E-Card can be sent to a large number of receivers by using a mailing list, with individual salutation for each individual receiver.

The invention enables selection of music from a library, or auto-select by the sender specifying a type of music, a composer, a period, or a title of the music. Also provided is a function to select greetings from a library of quotes, poetry, by subject, by author, by occasion, or by title of the poem, if know. The known art Electronic Greeting Card provides specific stock music, stock graphics, and stock greeting already embedded in each Electronic Greeting Card.

Some application examples of the present invention are gifting and greeting, by knowledge of receivers' interests and activities, anniversary gifting or greetings to friends and family, or sponsors and customers. General greeting and gifting to friends, relatives, and associates conducted in this fashion is more meaningful and useful. In addition, commercial promotions and advertising with active buying pathways and channels, and perhaps special discounts only available through the E-Commerce E-Card can be conducted through this invention.

In the conventional approach used in the know art, where a sender uses an E-Card site to select a specific E-card to be sent to a sender-specified receiver, the E-Card site sends an email-notification from the E-Card Site, telling the receiver the Sender Name, and with an URL of the Card in the mail. This requires the receiver to click-and-wait (for the down load) of the E-Card to see the e-Card. Often, the E-Card notification is not read, or not acted upon—meaning the email is read but the link to the E-Card is not clicked.

The present invention facilitates sending the E-Card from/with the Sender's email address appearing in the receivers email inbox screen, and its attractive thumbnail of the graphics or pictorial representation appear directly on the recipient's email screen, when an embedded link in the attractive graphics or pictorial representation is more likely to be clicked from the email body or even from the Inbox screen. The recipient does not have to click on an unattractive textual UR L link appearing in an email sent by an E-Card site, and wait for the data transmission to download the E-Card onto the receiver computer's display screen. The connection to the source site is made when an active function such as an icon to link to the service provider, an icon to link to the merchant or the service provider, or the icon to “buy”, or when a pathway icon to conduct a commerce transaction for an object on the E-Card is selected and activated.

Another service spawned from this invention is that our e-Card facility allows merchant sites to enable senders to select graphics from online catalogs to send to a receiver. Another service is a portal site that enables a user to upload their own photographs, video, music, and audio, for example, of their travels, their children, their activities, or from any off-line or online libraries and catalogs available to them to compose an E-Card to send to an intended receiver. With this invention, a highly personalized E-Card or E-Commerce E-Card can be composed and sent through a social media hosting site.

In knowing the current interests and endeavors of a friend, a relative, a customer, an employee, an associate, or a multitude of friends, associates, relatives, customers, and employees, attractive information and active pathway to commercial transaction channels of a class of special merchandize or services that suite the interest and activities of target receivers can be selected and composed into the form of the E-Commerce E-Card as described in this disclosure. Sending E-Cards of this nature is superior to the known-art “standard stock” E-Cards, and known-art product promotion emails.

The present invention enables the expression of the sender's knowledge and interest in the interests, activities, and endeavors of the receivers. When receiving a standard E-Card of the known art, the receiver may or may never see the E-Card. And if the receiver clicks the textual link and waits to see the card, the typical receiver response action is “read and discard,” If the receiver has a close enough relationship with the sender, maybe the receiver would send a separate thank-you email to the sender. Other than that, there is nothing for the receiver to do.

In contrast, the present invention presents beautiful pictures of objects, contains links to useful information about the objects, and access channels to the objects, whether the objects selected by the sender are parks, ballet performances, fancy dinners, beautiful clothes, useful services, they are more likely to be objects and information relevant to the receivers' needs and interests.

The present invention also enables a group of people to combine resources to purchase a gift for a common friend or relative. A member of the group may select ideas for the gift, drag and drop the pictures, basic information, and links to detailed information and pricing onto an E-Commerce-E-Card Composition screen, enter appropriate questionnaire(s), and make entry box for receiving feedback, and then send to the group members. Multiple of these cards maybe composed and sent by multiple members, and a tally facility would combine the multiple cards and the responses, present one or more of the most popular gift options and the volunteered contribution from each member from each member for the one or more gift options, as well as provide a pathway to execute the purchasing and sharing of costs among the group members for the group's finally selected at least one gift option.

A gift registration site or a social media site can also be configured to host this invention. Friends and relatives, as well as the to-be-receiver(s) of the gifts can compose E-Commerce E-Cards on the site with objects found on the site or elsewhere on the Internet and thought to be highly attractive and useful, send the E-Commerce E-Cards to a group of friends and relatives, as well as the to-be receivers to receive comments, feedback and rating. Tallied result would determine what objects are posted on the registry of the to-be-receiver(s).

1. A computer-implemented method for conducting on-line commerce, comprising:
creating an electronic card that contains a pictorial representation of at least one object available for a commercial transaction;
associating the pictorial representation of the at least one object with a URL link to a webpage containing information about the at least one object;
providing on the electronic card a pathway for conducting a commercial transaction related to the at least one object;
sending the electronic card in association with an electronic message to a recipient; and
sending, by the recipient, the electronic card in an edited form to a further recipient.

2. The method of claim 1, wherein the electronic card's full visual content is displayed within the content of the electronic message.

3. The method of claim 1, wherein the electronic card's full visual content is viewable by activating a link displayed in the electronic message.

4. The method of claim 1, wherein a graphic thumbnail representing the full visual content of the electronic card is displayed in the electronic message, the thumbnail embedding a link to the full visual content of the electronic card.

5. The method of claim 1, wherein a card creation facility associated with the electronic card is hosted by a gift card site.

6. The method of claim 1, wherein a card creation facility associated with the electronic card is hosted by a merchant site.

7. The method of claim 1, wherein a card creation facility associated with the electronic card is hosted by an event planning site.

8. The method of claim 1, wherein a card creation facility associated with the electronic card is hosted by a portal site.

9. The method of claim 1, wherein a card creation facility associated with the electronic card is hosted by a greeting card site.

10. The method of claim 1, wherein the pathway is capable of being exercised by the sender.

11. The method of claim 1, wherein a recipient of the electronic card may respond to the electronic card by selecting an icon indicative of whether the recipient liked the electronic card.

12. The method of claim 1, wherein the electronic card is capable of being chosen among a repository of pre-created electronic cards displayed by a hosting site.

13. The method of claim 1, wherein the pictorial representation may be selected to initiate a commercial transaction.

14. The method of claim 13, wherein the pictorial representation is associated with a movie.

15. The method of claim 13, wherein the pictorial representation further comprises at least one object capable of being selected to initiate a commercial transaction.

16. The method of claim 13, wherein the pictorial representation is associated with a geographic location capable of being physically visited.

17. The method of claim 1, wherein the electronic card provides a mechanism for the receiver to send a response to the sender.

18. The method of claim 1, wherein the electronic card is pre-composed with a visual representation of at least one object capable of being customized by a user and further capable of being selected to initiate a commercial transaction.

19. The method of claim 1, wherein the electronic card is associated with a gift registry.

20. The method of claim 12, wherein the repository is associated with a website for purchasing gifts.

21. The method of claim 1, wherein the gift card is embedded within the electronic card.

22. The method of claim 11, wherein the electronic card further comprises a mechanism for a receiver of information related to whether the recipient likes the electronic card to select a response to the sender of said information.

23. The method of claim 11, wherein a mechanism to conduct a commercial transaction is capable of being initiated based on the recipient's response to the electronic card.

24. The method of claim 1, wherein the URL link is to a webpage through which the recipient of the electronic card may purchase an item associated with the pictorial representation.

25. The method of claim 24, wherein the URL link corresponds to a webpage that displays information about the pictorial representation and that indicates that an item associated with the pictorial representation has been pre-purchased for the recipient of the electronic card.

26. The method of claim 1, wherein the entirety of the electronic card is viewable within the recipient's electronic message preview browser.

27. A computer-implemented method for conducting on-line commerce, comprising:
creating an electronic card that is visually displayed in the content of an electronic message to be sent to a recipient and embedding within the card a pathway to a webpage;
sending the electronic card, to a recipient, within an electronic message, wherein the electronic message is capable of responding to input from the recipient of the electronic message; and
sending, by the recipient, the electronic card in an edited form to a further recipient.

28. The method of claim 27, wherein the electronic card contains a pathway to objects for purchase.

29. The method of claim 27, wherein the recipient of the electronic message is a customer of a merchant associated with the webpage referenced within the electronic message.

30. The method of claim 27, wherein the webpage referenced within the electronic message contains links to purchase an item.

31. The method of claim 27, wherein the webpage displays information about an item and indicates that the item has been pre-purchased for the recipient of the electronic mail.

32. A computer-implemented method for conduct on-line commerce, comprising:
creating an electronic card that is visually displayed in the content of an electronic message to be sent to a recipient and embedding visual and audio content within the card;
associating the visual content with a URL link;
associating the audio content with a URL link to an audio file;
associating the electronic card with a pathway for conducting a commercial transaction;
sending the electronic card to a recipient within an electronic message, wherein the electronic card is viewable within the content of the electronic message; and
sending, by the recipient, the electronic card in an edited form to a further recipient.

33. The method of claim 32, wherein the visual content includes a pictorial representation and a URL link to a webpage containing information about the pictorial representation is associated with the pictorial representation.

34. The method of claim 32, wherein the visual content includes a video file.

35. The method of claim 34, wherein the video file contains a pre-recorded video message.

36. The method of claim 32, wherein the audio file contains a pre-recorded audio message.

37. The method of claim 32, wherein the audio content comprises music.

38. The method of claim 32, wherein the entirety of the electronic card is viewable within the recipient's electronic message preview browser.

39. The method of claim 33, wherein the URL link associated with the pictorial representation corresponds to a webpage through which the recipient of the electronic card may purchase the item set forth in the pictorial representation.

40. The method of claim 33, wherein the URL link associated with the pictorial representation corresponds to a webpage that displays information about the pictorial representation and that indicates that an item associated with the pictorial representation has been pre-purchased for the recipient of the electronic card.
